(19) United States
(12) Patent Application Publication
(10) Pub. No.: US 2022/0001336 A1
(43) Pub. Date: Jan. 6, 2022

(54) Methods of Cleaning Filter Membranes in Wastewater Treatment

(71) Applicant: Ovivo Inc., Montreal (CA)

(72) Inventor: Trevor Auman, Sandy, UT (US)

(21) Appl. No.: 17/304,935

(22) Filed: Jun. 28, 2021

Related U.S. Application Data
(60) Provisional application No. 63/047,097, filed on Jul. 1, 2020.

(51) Int. Cl. B01D 65/02; B01D 63/08

(52) U.S. Cl. CPC B01D 65/02; B01D 2321/30; B01D 2321/02; B01D 63/082

(57) ABSTRACT

Filter membranes in systems for drinking water, tertiary water treatment and combined sewage overflow, MBR and MBT are efficiently cleaned without use of air scour. In one system the membranes, preferably flat plate membranes, are cleaned by mechanically driven wipers that can clean the surfaces of two adjacent membranes simultaneously. Another system uses water jets to clean the membrane surfaces.

This application claims benefit of provisional application Ser. No. 63/047,097, filed Jul. 1, 2020.

### BACKGROUND OF THE INVENTION

This invention concerns membrane filtration, especially in wastewater treatment systems. In particular, the invention is directed to methods and systems for cleaning membrane surfaces, without the use of air scour.

In wastewater treatment systems for non-biological and biological treatment and industrial waste treatment, membrane filtration has been in increasing use. Membrane filtration can produce a nearly clean water filtrate or permeate, holding back even extremely small particles, including a variety of bacteria.

See, for example, Ovivo U.S. Pat. Nos. 7,922,829, 8,052,874, 8,308,939, 8,999,170, 9,174,862 and 9,862,628.

The membrane surfaces require periodic cleaning, to avoid buildup of rejected solids and material to the extent that flow of liquid through the membranes is considerably constricted. Typically these membranes, particularly flat plate membranes, have been cleaned with air scour, wherein the air bubbles emitted from aerators below the membranes release bubbles that rise up alongside the membrane surfaces and between membranes to loosen and remove filtered-out solids that eventually would clog the membrane pores. This air scour is often coupled with a backwashing through the membrane filters and/or chemical cleaning. However, air scour requires considerable energy with air pumps and blowers, aerators are vulnerable to clogging, and air scour is sometimes not 100% thorough. Of the above patents, U.S. Pat. Nos. 8,052,874, 9,174,862 and 9,862,628 involve air scour membrane cleaning.

### SUMMARY OF THE INVENTION

Pursuant to the current invention, filtration membranes, particularly in water and wastewater treatment systems, are cleaned without the use of air scour. In one implementation of the invention mechanical devices are moved across the surfaces of the membranes to wipe away the accumulated solids. These can include rubbery wipers or squeegees, moved by mechanical arm or carriage that advances along the length or width of a cartridge of membranes. The mechanical wipers can take other forms, such as fixed or rotating wire brushes.

In a separate implementation of the invention, water jets are positioned to direct high-velocity streams of water over the surfaces of the submerged membranes. The water streams can be directed essentially parallel to the membrane surfaces so as effectively to sweep the solids away, moving the material parallel to the membrane surface to settle at the bottom of a tank. Any of various mechanical systems can be provided to advance the mechanical cleaning devices or the water jets through a cycle of cleaning, to clean the entire surface area of each membrane.

### DESCRIPTION OF THE DRAWINGS

FIGS. 1 to 3 are perspective, elevation and detail views showing one embodiment of the invention, in which water jet sprays are used to clean membrane surfaces.

FIGS. 4 to 6 are perspective, elevation and detail section views showing another scheme for cleaning membrane surfaces with water jets.

FIGS. 7 to 9 are perspective, elevation and detail section views showing one example of mechanical contact cleaning of membrane surfaces.

FIGS. 10 to 12 are elevation, perspective and detail section views showing another form of mechanical cleaning arrangement for membranes.

### DESCRIPTION OF PREFERRED EMBODIMENTS

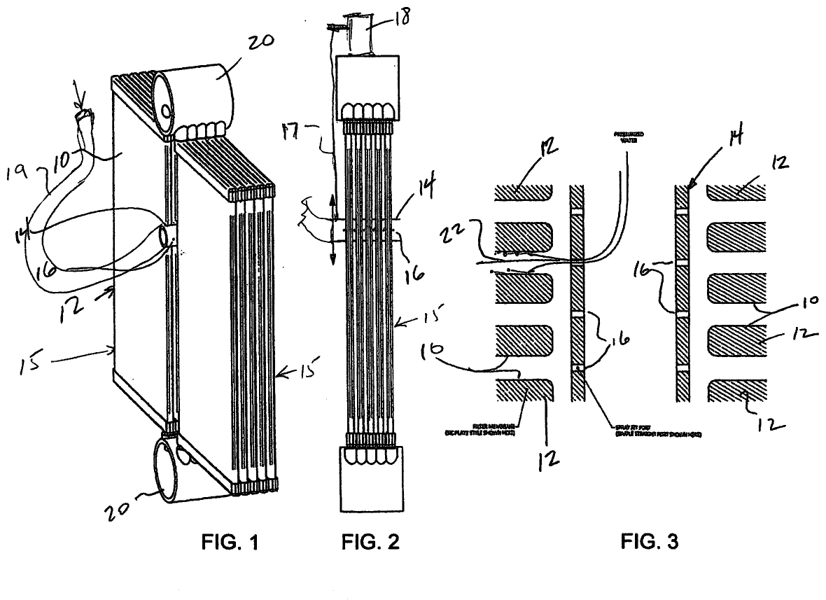

The drawings show different implementations of the invention, some involving water jet cleaning and some mechanical cleaning of the membranes. FIGS. 1 to 3 show a first embodiment using water jet sprays to clean surfaces 10 of membranes plates 12. FIGS. 1 and 2 show that the flat plate membranes 12 are in parallel vertical planes, i.e. plane-parallel as is typical, with narrow spaces between adjacent membrane surfaces. In this embodiment the cleaning device is a pipe or tube 14 having water jet nozzles, i.e. holes 16, aligned so they will direct spray between adjacent membrane surfaces from a position outside the cassette 15 of membranes, at edges of the membranes. In this implementation there are two cassettes 15 arranged in tandem. This delivery device 14 is moved up and down, as by cables as indicated schematically at 17 or other mechanical devices, with an example mechanism schematically indicated at 18 in FIG. 2. The delivery tube 14 receives water at relatively high pressure, ejecting jets of water through the holes or nozzles 16 as shown in FIG. 3.

The cassettes 15 can be submerged, with the cleaning done in situ.

A source of pressurized water, not shown, delivers the water through a flexible hose 19, in the illustrated embodiment, to the water delivery tube 14. This allows the up and down motion of the tube 14. A guided frame section (not shown) can be provided that holds the cleaning device 14 and advances it up and down via a rigid arm or by cables as noted above.

Permeate exit tubes 20, or at least one of them, are provided for collecting the permeate from the membranes under suction.

FIG. 3, a detailed plan section view, looking down through a section of the nozzle tube 14, indicates schematically a jet of water 22. The nozzles 16 are configured, and the water pressure is such that the jet of water spreads as it rapidly flows between the membranes, so as to free debris collected along the membrane surfaces and direct it out from between the membranes. Note that references herein to “up” and “down” and other orientational words are intended to refer to a preferred embodiment and to describe positions of elements relative to one another, but not to limit the invention to such orientations. For example, the nozzle tube 14 could move horizontally along top or bottom edges of membrane plates in a cassette.

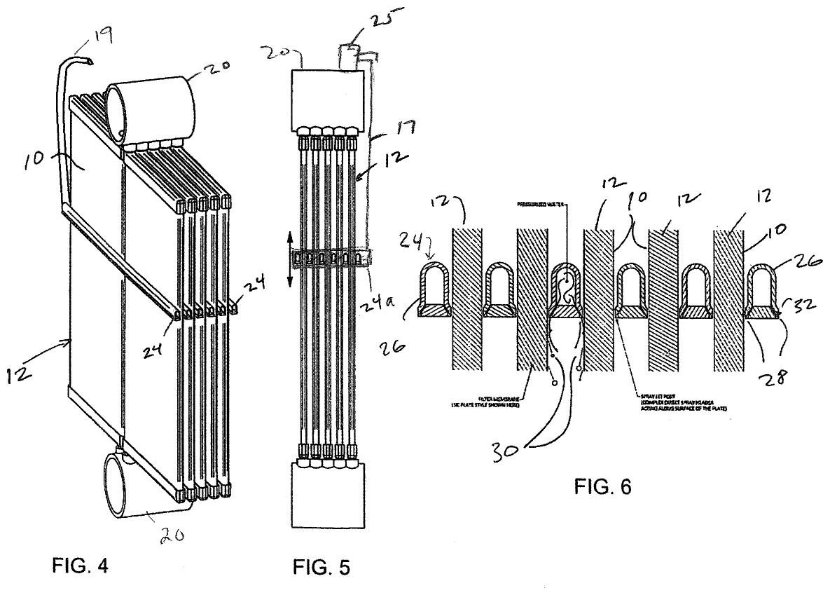

FIGS. 4 to 6 show another embodiment of the invention, again with water jets cleaning the surfaces 10 of membranes 12. Again, water jet delivery devices 24 are mechanically secured together and moved as a single unit down and up between the membranes and along the surfaces. A water jet moving device with e.g. a cable 17 operated by a motorized winch 25 or another mechanism not shown, moves the row of water jet devices 24 through the height of the membranes 12. FIG. 5 shows schematically a bar or frame piece 24a which binds the water jet delivery devices 24 at their ends. At the opposite ends is another mechanical connecting bar or securement to hold the devices to act together.

As shown particularly in FIG. 6, a sectional elevation view, the water jets in this preferred embodiment are directed downwardly/outwardly toward the membrane surfaces 10. Each water jet supporting tube 26 receives pressurized water from a source via the flexible tube 19 and directs water jets out through orifices 28. In FIG. 6 the flow of the water jets is illustrated at 30. In this particular embodiment the moving water delivery devices or tubes 26 extend very close to the surfaces 10 of the membranes. The sides of these water delivery devices 26 can actually be configured to wipe the surfaces 10 of the membranes, so that both mechanical cleaning and water jet cleaning is effected. Each of the movable water delivery devices can have flexible wiper blades on the two protruding sides, as at 32. Note that in this installation the water jets (as well as tubes 26 with wipers) move between the membrane plates themselves, not between rows or cassettes of membrane plates, i.e. between edges of plates, as in FIGS. 1-3.

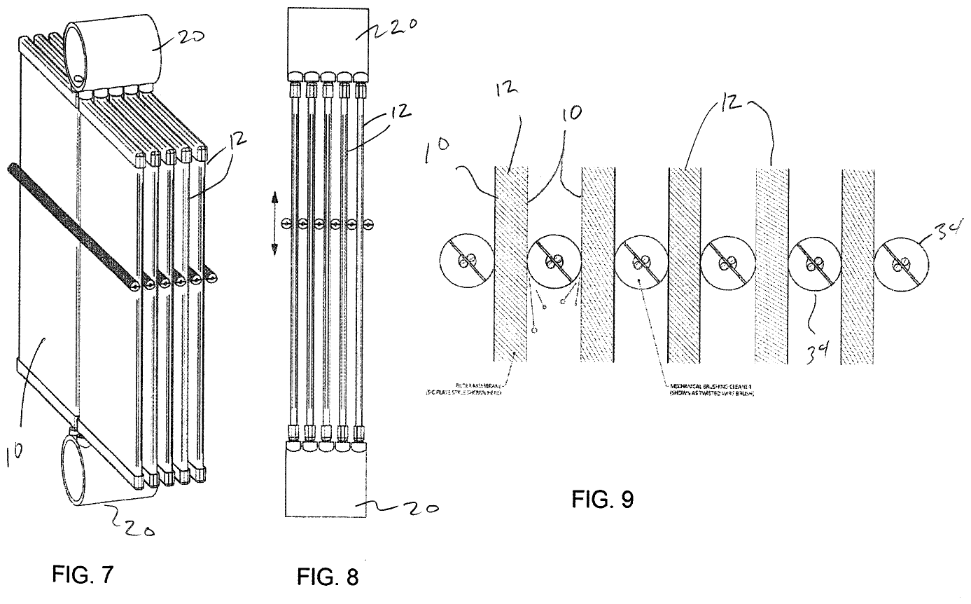

FIGS. 7 to 9 show another form of the invention, with mechanical cleaning of the surfaces 10 of the membranes 12. The mechanical cleaning devices are shown at 34. In one form of the invention these are twisted wire brushes, moved up and down by a mechanism similar to what is described above. Again, these brushes 34 are connected together at ends (not shown) so as to be advanced together. The brushes need not rotate, although they could be rotated in use. As they wear, they can be rotated to new angular positions at which they will be set, so as to expose new bristles to the membrane surfaces when needed.

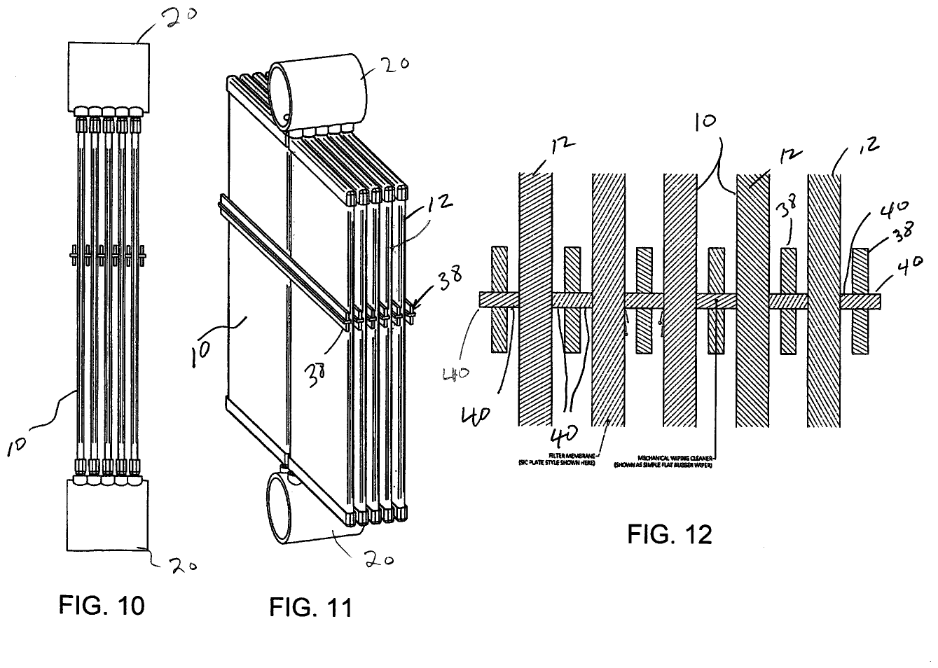

FIGS. 10 to 12 show another mechanical apparatus for cleaning membranes 12. The drawings are schematic, in that the frame or bars connecting the series of movable wiping devices 38 together are not shown. In FIGS. 7-12 the mechanical equipment (not shown) for moving the cleaning devices does not include a water supply hose. Note that the movement mechanism can be similar to that of FIGS. 1-6.

FIG. 12 shows, in a sectional elevation view, wiper blades 40 on each side of each wiping device 38, except at outsides of a cassette of membranes. The wiping devices 38 are moved in unison, with a frame or end connecting bars (not shown) as in the embodiments of FIGS. 4-9. Wipers 40 can be squeegees, i.e. flexible rubbery wipers.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

I claim:

1. A cleaning system for flat plate membranes of a membrane separation system in a wastewater treatment tank, comprising:
a series of flat plate membranes in plane-parallel arrangement, each being essentially oriented in a vertical plane and with spaces between adjacent membranes plates,
a water jet cleaner positioned to operate in the spaces between adjacent membrane plates, the cleaner including a source of pressurized water and a flexible tube or conduit delivering pressurized water from the header to a movable delivery tube oriented generally horizontally,
the delivery tube being positioned adjacent to edges of a series of adjacent membrane plates, with orifices in a side of the delivery tube positioned to eject jets of water into the spaces between adjacent plates of the series of membrane plates, and
a mechanism for moving the delivery tube up and down adjacent to the ends of the series of membrane plates, so as to enable spraying said jets of water between each pair of adjacent membrane plates while moving the delivery tube up or down so as to clean an entire face of each membrane plate.

2. The cleaning system of claim 1, including two said series of membrane plates, each arranged in a cassette, the cassettes being situated in tandem, all membrane plates being in generally vertical planes and parallel, with a clearance space between edges of membrane plates of the two series, and with the delivery tube positioned in said clearance space, the delivery tube having nozzles directed in essentially two opposed directions, toward each of the two series of membrane plates so that both series of membrane plates are cleaned while the delivery tube is moved up or down spraying said jets of water.

3. The cleaning system of claim 1, wherein the mechanism for moving the delivery tube up and down includes a tension cable for lifting or lowering the delivery tube.

4. A cleaning system for flat plate membranes of a membrane separation system in a wastewater treatment tank, comprising:
a series of flat plate membranes in plane-parallel arrangement, each being essentially oriented in a vertical plane and with spaces between adjacent membranes plates,
a series of elongated water jet delivery devices, connected together at least at one end and extending generally horizontally and parallel to one another, the water jet delivery devices being positioned in the spaces between adjacent membrane plates and being movable up and down through the spaces, with a mechanism for moving the water jet delivery devices up or down, and
a source of pressurized water, and a flexible hose extending from the source to water jet delivery devices to supply pressurized water, each of the elongated water jet delivery devices having a jet supporting tube for carrying the water and delivering water through water jets, with water jets at opposite sides of the water jet delivery device so as to direct jets of water at faces of two adjacent membrane plates simultaneously, as the series of water jet delivery devices is moved up or down along the membrane plates.

5. The cleaning system of claim 4, wherein the water jet delivery devices include wipers adjacent to the water jet nozzles, positioned to contact the faces of the membrane plates as the water jet delivery devices are moved up or down through the spaces between adjacent membrane plates, thereby cleaning the faces of the membrane plates.

6. A cleaning system for flat plate membranes of a membrane separation system in a wastewater treatment tank, comprising:
a series of flat plate membranes in plane-parallel arrangement, each being essentially oriented in a vertical plane and with spaces between adjacent membrane plates, and
a series of plate wipers, connected together at least at one end and extending parallel to one another and generally horizontally, the plate wipers being positioned in the spaces between adjacent membrane plates and being movable up and down through the spaces, with a mechanism for moving the plate wipers up or down,
whereby the flat plate membranes are effectively cleaned without use of air scour.

7. The cleaning system of claim 6, wherein the plate wipers easily comprise a cylindrical array of brushes positioned to contact and wipe the membrane plate faces.

8. The cleaning system of claim 7, wherein the cylindrical array of brushes are minimally adjustable in rotational orientation for accommodating wear of the brushes.
